(19) United States
(12) Patent Application Publication
(10) Pub. No.: US 2009/0013412 A1
(43) Pub. Date: Jan. 8, 2009

(54) Data Exchanging Device

(76) Inventor: Horst Nather, Villingen-Schwenningen (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 12/063,816

(22) PCT Filed: Jul. 25, 2006
(86) PCT No.: PCT/EP06/64639

§ 371 Date: Feb. 14, 2008

(30) Foreign Application Priority Data
Aug. 17, 2005 (EP) 10 2005 038 872.8

(51) Int. Cl. G06F 21/00

(52) U.S. Cl. 726/27

(57) ABSTRACT

A data exchanging device (1), particularly a tachograph (DTCO), for exchanging data in a manipulation-proof manner between a card (3) and the data exchanging device (1) has a logic unit (4) which monitors data exchange between the card (3) and the data exchanging device (1). Especially the also legally sensitive recorded data of a tachograph are secured from being manipulated during data exchange while reliably recognizing and registering manipulation attempts by configuring the logic unit (4) such that a manipulation incident is recorded in a memory (5) of the data exchanging device (1) and/or the card (3) when the card (3) is not physically or logically present.

### CROSS-REFERENCE TO RELATED APPLICATIONS

This application is a U.S. national stage application of International Application No. PCT/EP 2006/064639 filed Jul. 25, 2006, which designates the United States of America, and claims priority to German application number 10 2005 038 872.8 filed Aug. 17, 2005, the contents of which are hereby incorporated by reference in their entirety.

### TECHNICAL FIELD

The invention relates to a data exchanging device, in particular a data exchanging device of a tachograph, for exchanging data in a manipulation-proof manner between a card and the data exchanging device, which card has a data memory, wherein the data exchanging device has a logic unit which monitors the exchange of data between the card and the data exchanging device.

### BACKGROUND

In commercial goods and passenger transportation, the operational data of the utility vehicles is recorded in a person-related manner by means of a tachograph. According to EEC Regulation 3820 there is provision for new vehicles to be equipped with a new generation of tachographs which, in contrast to the old design, no longer records the operational data in analog form on a paper diagram disk but instead stores it in digital form in a memory, wherein each driver of a vehicle is assigned a data card which can be connected to the tachograph in order to exchange data with it. For this purpose, there is provision for the tachograph to completely accommodate the card so that attempts at manipulation during the transmission of data between the tachograph and the data memory of the card continue to be unsuccessful. A tachograph of this type is already known from European patent EP 0 794 499 B1. The change to digital recording of the operational data entails the risk that it can become possible to manipulate the latter and that the valuable character of these recordings as legal evidence could be lost. For this reason, extensive efforts are being made to prevent attempts at manipulation from becoming successful. For example, the writing access to the data memory of a card is possible only after reliable authentication of the other party to the communication. In addition, the hardware used in the tachograph is protected against all currently conceivable attacks.

### SUMMARY

Protection against manipulation of the data of recordings of a tachograph, which data is also sensitive legally, during the exchange of data, and of reliably detecting attempts at manipulation and recording them so that manipulation can be tracked chronologically as an event can be achieved by an embodiment of a data exchanging device of a tachograph, for exchanging data in a manipulation-proof manner between a card and the data exchanging device, wherein the card has a data memory and wherein the data exchanging device has a logic unit which monitors the exchange of data between the card and the data exchanging device, wherein the logic unit is operable such that a simulation of an arrangement of the card at a specific location of the data exchanging device and/or a simulation of an exchange of data with the card is recorded in a memory of the data exchanging device, if the card is not arranged at the specific location of the data exchanging device or if no exchange of data takes place with the card.

According to a further embodiment, at least one sensor can be provided which detects whether the card is located in a region of the data exchanging device which is suitable for an exchange of data, the sensor is connected to the logic unit, and the logic unit detects the card as being arranged at the specific location of the data exchanging device if the sensor signals the presence of the card. According to a further embodiment, the exchange of data which takes place with the card can be detected by the logic unit if an undisrupted exchange of data takes place. According to a further embodiment, the logic unit may detect an exchange of data as undisrupted if the content of the memory can be read out completely. According to a further embodiment, the card may comprise connection contacts, the data exchanging device may have a data transmission interface which has a set of connection contacts and which is operable such that by means of said data transmission interface a data transmitting connection can be formed between the data exchanging device and the data memory, wherein in a first position of the card, the connection contacts bear against contacts of the set of connection contacts, wherein the data exchanging device has at least a second sensor which detects whether the card is located in the first position, and the logic unit is operable such that the logic unit detects the card as not being arranged at the specific location of the data exchanging device if the second sensor signals that the card is not located in the first position. According to a further embodiment, the card may comprise connection contacts, the data exchanging device may comprise a data transmission interface which has a set of connection contacts and is operable such that by means of said data transmission interface a data transmitting connection can be formed between the data exchanging device and the data memory, wherein the data exchanging device has a locking unit which, if located in a first position, secures the card arranged at the specific location of the data exchanging device in a first position in which the connection contacts bear against contacts of the set of connection contacts, wherein the data exchanging device has at least a first sensor which detects whether the locking unit is located in a first position, and the logic unit is operable such that a manipulation event is recorded in a memory of the data exchanging device and/or of the card if the first sensor signals that the locking unit is not located in the first position. According to a further embodiment, the data exchanging device may be operable such that, after a data transmitting connection has come about between the data exchanging device and the data memory, it firstly reads out the data memory completely. According to a further embodiment, the logic unit may cyclically carry out checking by means of the first sensor and/or the second sensor to determine whether the locking unit is in the first position or the card is located in the first position. According to a further embodiment, the data exchanging device may be operated by means of an operating voltage, and after the operating voltage has been switched on the data exchanging device checks whether the card is arranged at the specific location of the data exchanging device.

### BRIEF DESCRIPTION OF THE DRAWINGS

In the text which follows the invention will be clarified in more detail by means of a specific exemplary embodiment and with reference to drawings, in which:

FIG. 1 is a schematic illustration of the interaction of a card with a data exchanging device of a tachograph according to an embodiment, and

FIG. 2 is a schematic illustration of the process sequence according to an embodiment after the operating voltage of a data exchanging device or of a tachograph has been switched on.

### DETAILED DESCRIPTION

The data exchanging device according to an embodiment may be preferably a component of a tachograph and may be expediently arranged here in a common housing with other components of a tachograph, for example a display unit, a mass storage means for recording the operational data, a printer for outputting events from different evaluations of the operational data or an automated card accommodation device which automatically feeds an inserted card into the interior of the tachograph or outputs it given a corresponding request. The data card which is used expediently may have a data memory, a processor and an encryption unit which permits at least the protection of writing processes in the data memory of the card. A manipulation event according to an embodiment or a corresponding memory entry is understood to be the assignment of a time to the registered manipulation process. Physical presence is understood to be the arrangement of the card at a specific location on the data exchanging device which permits an exchange of data. The logical presence of the card means here the occurrence of an exchange of data. A decisive advantage of the various embodiments is the combination of the two criteria which determine that a manipulation event will be entered in the memory of the data exchanging device or of the card. Any attempt at manipulation can in this way be restricted not only to simulating the physical presence of a card or of simulating the logical presence of the card by means of a data transmission but, as an aggravating factor, an attempt at manipulation must, according to various embodiments, meet both criteria in order to remain unnoticed.

An expedient possible way of detecting the physical presence of the card is that at least one sensor is provided which detects whether the card is located in a region of the data exchanging device which is suitable for an exchange of data, the sensor is connected to the logic unit and the logic unit detects the card as being physically present if the sensor signals the presence of the card. An undisrupted exchange of data between the data exchanging device and the logic unit is expedient as a particularly reliable criterion for the logical presence of the card, in particular if the content of the memory of the card can be read out completely from the data exchanging device.

One embodiment provides that the card has connection contacts, that the data exchanging device has a data transmission interface which has a set of connection contacts and is embodied in such a way that by means of said data transmission interface a data transmitting connection can be formed between the data exchanging device and he data memory, and that, in a first position of the card, the connection contacts bear against contacts of the set of connection contacts, wherein the data exchanging device has at least a second sensor which detects whether the card is in the first position, and the logic unit is embodied in such a way that it detects the card as not being physically present if the second sensor signals that the card is not located in the first position. Another possible embodiment of checking the physical presence of the card consists in the fact that the data exchanging device which can form a data transmitting connection with the card by means of contact has a locking unit which, if it is in a first position, secures the physically present card in a first position in which contact, which permits the transmission of data, occurs between the data exchanging device and the card, wherein at least a first sensor which detects whether the locking unit is located in the first position is provided, and the logic unit is embodied in such a way that a manipulation event is recorded in a memory of the data exchanging device and/or of the card if the second sensor signals that the locking device is not located in the first position. This criterion for the recording of a manipulation event acts, as it were, preventively since intervention in the locking mechanism of a data exchanging device or of a tachograph is generally necessary in order to carry out manipulation even though the flow of data does not yet have to have been influenced.

An embodiment of the data exchanging device such that after a data transmitting connection has come about between the data transmitting device and the data memory said data exchanging device firstly completely reads out the data memory can be particularly effective for detecting an attempt at manipulation of the software. In this way, the entire memory content of the data memory is checked at the beginning. In order also to be able to track attempts at manipulation during ongoing operation of the data exchanging device or of a tachograph, it may be expedient if the logic unit cyclically carries out checking by means of the first sensor and/or the second sensor to determine whether the locking unit is in the first position and/or the card is located in the first position. Since the data exchanging device or a tachograph is vulnerable to manipulation after selection of an operating voltage due to the elimination of various voltage-bound monitoring mechanisms, it may be expedient if subsequent to the switching on of the operating voltage the data exchanging device checks whether the card is physically present.

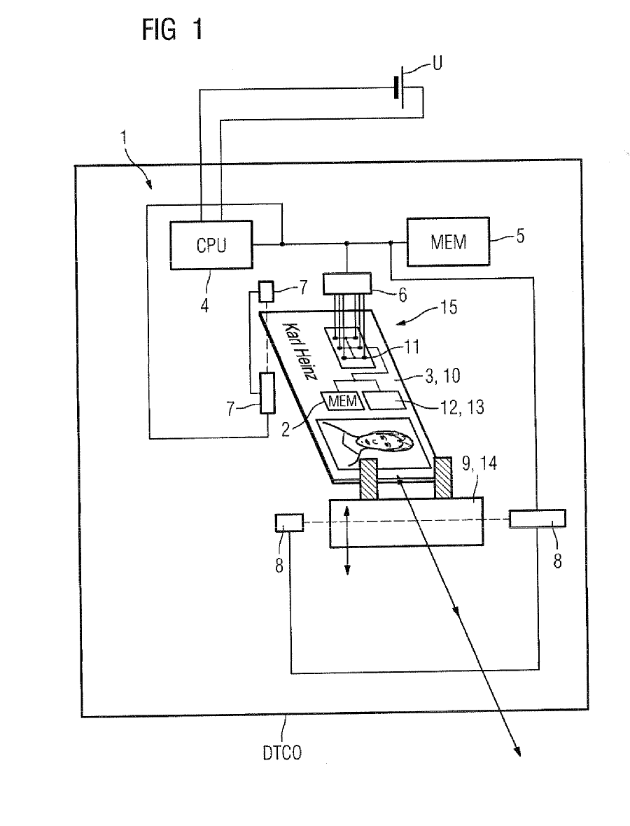

FIG. 1 is a schematic illustration of a data exchanging device 1 according to an embodiment as a component of a tachograph DTCO interacting with a card 3 which has a data memory 2. Essential components of the data exchanging device 1 are a logic unit 4, a memory 5, a set 6 of connection contacts, sensors 7, 8 and a locking unit 9. When the card 3 is input into the data exchanging device 1 of the tachograph DTCO, the card reaches a first position 10 in the data exchanging device 1 in which the

set 6 of connection contacts comes to bear against connection contacts 11 so that an electrical connection is established between the data exchanging device 1 and the card 3. The set 6 of connection contacts is connected to the logic unit 4 and the memory 5 in the data exchanging device 1. The connection contacts 11 have, in addition, a connection to the data memory 2 and to a processor 12 and an encryption unit 13 of the card 3. Accordingly, when the card 3 is placed in the first position 10 a data transmitting connection is produced between the data memory 2 of the card 3 and the memory 5 of the data exchanging device 1 or of the tachograph DTCO and recording data can be read out of the data memory 2. The data memory 2 only permits a “read-only” access without corresponding authentication. When the card 3 is placed in the first position 10, the locking unit 9 closes the insertion opening (not illustrated) of the data exchanging device 1 or of the tachograph DTCO, so that the card 3 is secured in the first position 10. A first sensor 7 detects the physical presence of the card 3 in the first position and signals this to the logic unit 4. A second sensor 8 signals that a first position 14 of the locking unit 9, which secures the card 3, in the first position 10, to the logic unit 4, has been reached. The logic unit 4 cyclically checks the physical presence of the card 3 by means of the sensors 7, 8 and, when the signals from the sensors 7, 8 differ, it causes the memory entry to be made for an attempt at manipulation, firstly in the memory 5 and subsequently in the data memory 2. In addition, the logic unit 4 also checks the logical presence of the card 3 in that the presence of a fault in the exchange of data at the data transmission interface 15 which comprises the set 6 of connection contacts and the connection contacts 11 is also detected as a reason to make an entry for a manipulation event in the memory 5 or the data memory 2.

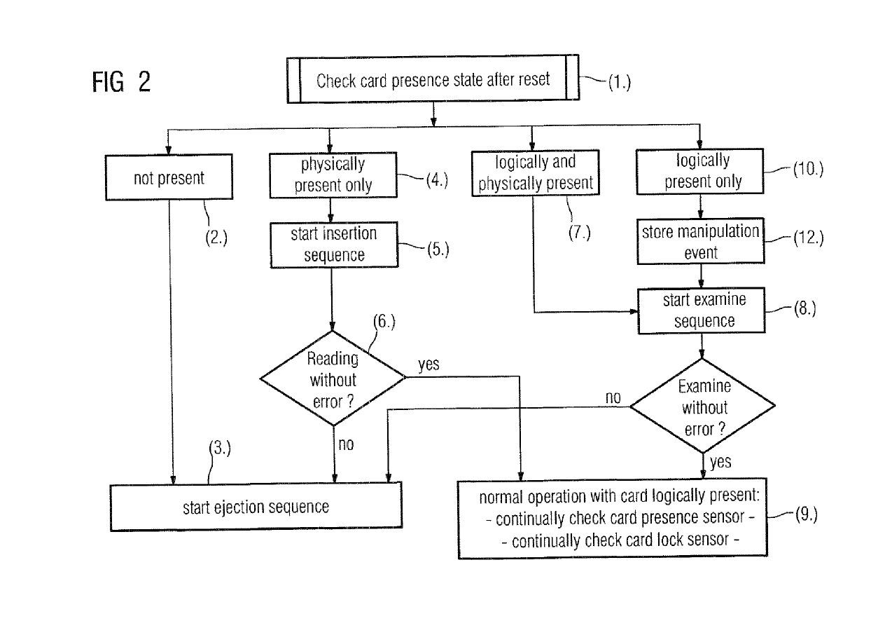

The data exchanging device 1 or the tachograph DTCO is operated by means of an operating voltage U, FIG. 2 illustrating a sequence after the operating voltage U has been switched on. In a first step 1, the data exchanging unit 1 checks whether the card 3 is present. In particular, it checks both the logical presence and the physical presence in the previously described way. If the card 3 is not present either logically or physically (2.), ejection of the card (3.) occurs. If the data exchanging device 1 detects that the card 3 is physically present (4.), it is automatically drawn in (5.) and an attempt is made to read it (6.). If the result of the reading process (6.) is a fault message, ejection (3.) of the card 3 occurs. If the logic unit 4 detects that the card 3 is both logically and physically present (7.), an examination sequence (8.) is initiated, and this leads to ejection (3.) of the card 3 in the event of a faulty outcome, and results in normal operation (9.) of the data exchanging device 1 or of the tachograph DTCO in the event of a faultfree outcome. If the logic unit 4 detects a merely logical presence (10.) of the card 3, said logic unit 4 brings about the registration of a manipulation event (12.) and initiates the already previously mentioned examination sequence (8.).

What is claimed is:

1. A data exchanging device, of a tachograph, for exchanging data in a manipulation-proof manner between a card and the data exchanging device, wherein the card has a data memory and wherein the data exchanging device has a logic unit which monitors the exchange of data between the card and the data exchanging device, wherein the logic unit is operable such that a simulation of an arrangement of the card at a specific location of the data exchanging device and/or a simulation of an exchange of data with the card is recorded in a memory of the data exchanging device, if the card is not arranged at the specific location of the data exchanging device or if no exchange of data takes place with the card.

2. The data exchanging device according to claim 1, wherein at least one sensor is provided which detects whether the card is located in a region of the data exchanging device which is suitable for an exchange of data, the sensor is connected to the logic unit, and the logic unit detects the card as being arranged at the specific location of the data exchanging device if the sensor signals the presence of the card.

3. The data exchanging device according to claim 1, wherein the exchange of data which takes place with the card is detected by the logic unit if an undisrupted exchange of data takes place.

4. The data exchanging device according to claim 3, wherein the logic unit detects an exchange of data as undisrupted if the content of the memory can be read out completely.

5. The data exchanging device according to claim 1, wherein the card comprises connection contacts, the data exchanging device has a data transmission interface which has a set of connection contacts and which is operable such that by means of said data transmission interface a data transmitting connection can be formed between the data exchanging device and the data memory, wherein in a first position of the card, the connection contacts bear against contacts of the set of connection contacts, wherein the data exchanging device has at least a second sensor which detects whether the card is located in the first position, and the logic unit is operable such that the logic unit detects the card as not being arranged at the specific location of the data exchanging device if the second sensor signals that the card is not located in the first position.

6. The data exchanging device, according to claim 1, wherein the card comprises connection contacts, the data exchanging device comprises a data transmission interface which has a set of connection contacts and is operable such that by means of said data transmission interface a data transmitting connection can be formed between the data exchanging device and the data memory, wherein the data exchanging device has a locking unit which, if located in a first position, secures the card arranged at the specific location of the data exchanging device in a first position in which the connection contacts bear against contacts of the set of connection contacts, wherein the data exchanging devices has at least a first sensor which detects whether the locking unit is located in a first position, and the logic unit is operable such that a manipulation event is recorded in a memory of the data exchanging device and/or of the card if the first sensor signals that the locking unit is not located in the first position.

7. The data exchanging device according to claim 3, wherein the data exchanging device is operable such that, after a data transmitting connection has come about between the data exchanging device and the data memory, it firstly reads out the data memory completely.

8. The data exchanging device according to claim 2, wherein the logic unit cyclically carries out checking by means of the first sensor and/or the second sensor to determine whether the locking unit is in the first position or the card is located in the first position.

9. The data exchanging device according to claim 1, wherein the data exchanging device is operated by means of an operating voltage, and after the operating voltage has been switched on the data exchanging device checks whether the card is arranged at the specific location of the data exchanging device.

10. A method for exchanging data in a manipulation-proof manner between a card and a data exchanging device of a tachograph, wherein the card has a data memory and wherein the data exchanging device has a logic unit which monitors the exchange of data between the card and the data exchanging device, the method comprising the step of:
if the card is not arranged at the specific location of the data exchanging device or if no exchange of data takes place with the card, recording a simulation of an arrangement of the card at a specific location of the data exchanging device and/or simulation of an exchange of data with the card in a memory of the data exchanging device.

11. The method according to claim 10, further comprising the step of detecting by a sensor whether the card is located in a region of the data exchanging device which is suitable for an exchange of data, wherein the sensor is connected to the logic unit, and the logic unit detects the card as being arranged at the specific location of the data exchanging device if the sensor signals the presence of the card.

12. The method according to claim 10, wherein the exchange of data which takes place with the card is detected by the logic unit if an undisrupted exchange of data takes place.

13. The method according to claim 12, wherein the logic unit detects an exchange of data as undisrupted if the content of the memory can be read out completely.

14. The method according to claim 10, wherein the card comprises connection contacts, the data exchanging device comprises a data transmission interface which has a set of connection contacts and the method comprising the further steps of forming a data transmitting connection by means of said data transmission interface between the data exchanging device and the data memory, wherein in a first position of the card, the connection contacts bear against contacts of the set of connection contacts, detecting by at least a second sensor whether the card is located in the first position, and detecting whether the card is not being arranged at the specific location of the data exchanging device if the second sensor signals that the card is not located in the first position.

15. The method according to claim 10, wherein the card comprises connection contacts, the data exchanging device comprises a data transmission interface which has a set of connection contacts and the method comprises the steps of forming a data transmitting connection by means of said data transmission interface between the data exchanging device and the data memory, which data exchanging device has a locking unit which, if located in a first position, secures the card arranged at the specific location of the data exchanging device in a first position in which the connection contacts bear against contacts of the set of connection contacts, and detecting by at least a first sensor whether the locking unit is located in a first position, and recording a manipulation event in a memory of the data exchanging device and/or of the card if the first sensor signals that the locking unit is not located in the first position.

16. The method according to claim 12, further comprising the step of: after a data transmitting connection has come about between the data exchanging device and the data memory, the data exchange device firstly reads out the data memory completely.

17. The method according to claim 11, wherein the logic unit cyclically carries out checking by means of the first sensor and/or the second sensor to determine whether the locking unit is in the first position or the card is located in the first position.

18. The method according to claim 10, wherein the data exchanging device is operated by means of an operating voltage, and after the operating voltage has been switched on the data exchanging device checks whether the card is arranged at the specific location of the data exchanging device.
